(19) United States
(12) Patent Application Publication
(10) Pub. No.: US 2017/0200117 A1
(43) Pub. Date: Jul. 13, 2017

(54) SYSTEMS AND METHODS OF FULFILLING PRODUCT ORDERS

(71) Applicant: Wal-Mart Stores, Inc., Bentonville, AR (US)

(72) Inventors: Donald R. High, Noel, MO (US); Michael D. Atchley, Springdale, AR (US); Nicholas R. Antel, Springdale, AR (US)

(21) Appl. No.: 15/398,103

(22) Filed: Jan. 4, 2017

Related U.S. Application Data
(60) Provisional application No. 62/275,871, filed on Jan. 7, 2016.

(51) Int. Cl. G06Q 10/08; G02B 27/01; G06F 3/14

(52) U.S. Cl. CPC G06Q 10/087; G06F 3/1423; G02B 27/0172; G02B 2027/0138; G02B 2027/014

(57) ABSTRACT

In some embodiments, apparatuses and methods are provided herein useful to fulfill product orders. In some embodiments, a product order fulfillment system, comprises: a plurality of Optical Head-Mounted Display (OHMD) systems; and a customer order fulfillment system associated with a retail store and configured to wireless communicate with each of the plurality of OHMD systems, and comprising a fulfillment management circuit configured to: receive multiple different product orders; determine separate product collection routes through the retail store that are each to be respectively followed by one of one or more workers; and wirelessly communicate route information and product identifier information to the OHMD systems and cause the route information and the product identifier information to be visually displayed through the OHMD systems.

### CROSS-REFERENCE TO RELATED APPLICATION

This application claims the benefit of U.S. Provisional Application No. 62/275,871, filed Jan. 7, 2016, which is incorporated herein by reference in its entirety.

### TECHNICAL FIELD

This invention relates generally to fulfilling product orders.

### BACKGROUND

In a modern retail environment, there is a need to improve the customer service and/or convenience for the customer. One aspect of customer service is providing customers with access to products and/or the delivery of products. There are numerous ways to delivery products to customers. Collecting the ordered product, however, can cause undesirable delays, can add cost, and reduce revenue.

### BRIEF DESCRIPTION OF THE DRAWINGS

Disclosed herein are embodiments of systems, apparatuses and methods of fulfilling product orders. This description includes drawings, wherein:

FIG. 1 illustrates a simplified block diagram of an exemplary product order fulfillment system, in accordance with some embodiments.

FIG. 2 illustrates a simplified block diagram of an exemplary fulfillment management circuit, in accordance with some embodiments.

FIG. 3 illustrates a simplified block diagram of an exemplary Optical Head-Mounted Display (OHMD) system, in accordance with some embodiments.

FIG. 4 illustrates a simplified flow diagram of an exemplary process of fulfilling product orders through one or more retail stores, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to fulfill product orders, typically from a shopping facility. Some embodiments provide a product order fulfillment system that includes and/or utilizes a plurality of Optical Head-Mounted Display (OHMD) systems that can be associated with and worn by workers at a shopping facility. The fulfillment system further includes a customer order fulfillment system, associated with the retail store or other shopping facility, that wirelessly communicates with each of the plurality of OHMD systems. In some applications the customer order fulfillment system includes a fulfillment management circuit that receives multiple different product orders to be fulfilled at the retail store, and determines separate product collection routes through the retail store that are each to be respectively followed by one of one or more workers to collect the requested products for the multiple different product orders. Typically, the collection routes are defined so that any aisle from which one of the requested products is to be retrieved is only traveled along once by a single one of the one or more workers in retrieving the requested products stored along the respective aisle for the multiple product orders. The management circuit can cause route information corresponding to a respective one of the product collection routes and product identifier information of at least one of the requested products to be retrieved that is stored along the product collection routes to be wirelessly communicated to each of the OHMD systems associated with each of the one or more workers, and cause the route information and the product identifier information to be visually displayed through the respective one of the plurality of OHMD systems worn by each of the one or more workers.

FIG. 1 illustrates a simplified block diagram of an exemplary product order fulfillment system 100, in accordance with some embodiments. The product order fulfillment system includes one or more fulfillment management circuits (FMC) 102, a plurality of OHMD systems 104, and an order receiving system 106. In some applications the fulfillment management circuit is communicatively coupled with one or more memory storage and/or databases 110, and/or is part of a customer order fulfillment system that further includes and/or couples with one or more databases 110 and/or other electronic data storage components, which may store product information, customer information, product orders, retail store and product placement mapping, product identifier information, inventory information, and/or other such information. The fulfillment management circuit 102 is communicatively coupled with the OHMD systems 104, the order receiving system 106, and one or more databases 110 through one or more wired and/or wireless distributed communication networks 108 (e.g., one or more wired and/or wireless LANs, WANs, Internet, etc.). In some embodiments, the system may optionally include and/or communicatively couple with one or more inventory systems 112, a store and/or product mapping system 114, one or more point-of-sale (POS) systems 116, one or more scanner systems 120, one or more user interface units 122, and other relevant systems.

In some embodiments, the product order fulfillment system 100 is associated with a single retail store that customers enter and shop themselves for products, which are on display and/or for sale and variously distributed throughout a sales floor within the retail store. In other embodiments, the fulfillment system may be distributed over multiple retail stores. Typically, a single customer order is fulfilled through a single one of the retail stores. In some situations, however, a single customer order may be fulfilled through more than one retail store (e.g., when a first retail store does not have one or more ordered products). The fulfillment of the orders, however, are typically fulfilled through one or more retail stores instead of a distribution center, fulfillment warehouse, or the like. The retail store can be substantially any type of shopping facility at a location in which products for display and/or for sale are variously distributed throughout the shopping facility space. The facility may be any size of format facility, and may include products from one or more merchants. For example, a facility may be a single store operated by one merchant or may be a collection of stores covering multiple merchants such as a mall.

The one or more fulfillment management circuits 102 implement instructions stored in memory. In some embodiments, the fulfillment management circuit 102 receives multiple different product orders to be fulfilled at the retail store. Typically, the product orders are received from customers through an order receiving system 106. The order receiving system may, in some applications, be accessed by customer's using computers, laptops or other user interface units to identify one or more products, from hundreds to hundreds of thousands or millions of different products, to be purchased as part of a customer order. For example, the order receiving system may be in communication with, associated with and/or included as part of an Internet ecommerce site that allows customer to purchase products. The order receiving system may further be in communication with a POS system that confirms payment and completion of a customer order. The orders are stored in an orders memory and/or database of the product order fulfillment system 100 and accessible to the one or more fulfillment management circuits. One or more portals or other network access is configured to allow user interface units to submit orders and the order receiving system 106 to store those orders, update orders upon fulfillment of the orders and the like. Further, in some embodiments, processing received orders and split the ordered products and sort them by groupings or categories (e.g., meat, canned goods, produce, etc.), and with some categories by sub-categories. The groupings or categories may additionally or alternatively be grouped according the locations of products on the sales floor based on the product mapping. Some embodiments further maintain one or more supplier portals to the inventory system 112 enabling suppliers to track inventory, update inventory when the supplier delivers and/or stocks shelves, and the like.

Based on the multiple product orders, the fulfillment management circuit 102 determines separate product collection routes through the retail store that are each to be respectively followed by one of one or more workers to collect the requested products for one or more product orders. For example, multiple orders may be received each requesting one or more products. The fulfillment management circuit identifies where in the retail store the product can be obtained. This typically includes identifying locations on the sales floor that have been stocked to display the products and make the products available for other customers shopping in the retail store. In some embodiments, the fulfillment management circuit accesses one or more store mappings and/or databases that define the one or more locations within the shopping facility of each of the products available at the shopping facility. The mapping may be defined by 2-dimensional and/or 3-dimensional coordinates of the retail store, a 2-dimensional mapping, a 3-dimensional mapping, and/or other such mapping. The fulfillment management circuit typically further identifies a number of workers that are to be assigned and/or tasked with performing the collection of the ordered products in accordance with determined collection routes. The number of workers affects the number of collection routes to be determined, the general size of the collect routes, the number of products to be collected by each of the assigned workers, and other such factors. Accordingly, the fulfillment management circuit typically identifies a number of workers to be tasked with collecting products. The number of workers can depend on worker availabilities, number of products to be collected, distribution through the retail store of the ordered products, size and/or weight of products ordered, quantities of products ordered, ease of transport of products ordered, other such factors, and typically a combination of two or more of such factors.

In determining the collection routes, the fulfillment management circuit further attempts to optimize the collection routes in an effort to limit and/or prevent duplicative efforts by the one or more workers collecting the products for one or more product orders. This can include attempting to avoid having different workers collecting the same product for different orders, limiting and/or attempting to avoid having workers traveling along the same aisle in collecting different products on that same aisle, attempting to limit time and/or distances traveled by workers in collecting products allocated to those workers, and other such attempts to optimize collection, reduce collection times, limit duplicative efforts, and other such attempts to optimize product collection for multiple different product orders.

In some embodiments, for example, the fulfillment management circuit determines and/or obtains the collection routes for the one or more workers such that any aisle from which one of the requested products is to be retrieved is only traveled along once by a single one of the one or more workers in retrieving the requested one or more products stored along the respective aisle for one or more product orders. Additionally or alternatively, in some instances, the one or more collection routes are defined such that two workers do not travel into the same area of the retail store and/or sales floor while collecting products. It is noted that a second worker may travel down an aisle from which another worker is assigned to collect products, but is traveling along the aisle to get to another portion of the shopping facility and typically not collecting products on that aisle. Still further, some embodiments define the one or more collection routes such that a first worker collects one or more products within a given zone or area of the retail store, while one or more other workers collect one or more products from one or more other given zones of the retail store in collecting other products to obtain all of the products for one or more product orders being fulfilled. In some applications, areas and/or grids can be defined over an area of the retail store and/or portions of the retail store and the routing can be defined according to the grids. Some embodiments may group orders based on one or more factors, such as but not limited to quantity of merchandise, types of products, locations of products in the retail store, and the like.

The fulfillment management circuit 102 can identify OHMD systems 104 that are assigned to and/or associated with the one or more workers that are to be assigned to and/or are available to be assigned to collect at least one of the one or more products. Typically, a worker that may be assigned to collect products is assigned a particular OHMD system, and the assignment is stored in the fulfillment management circuit, database 110, a task management system, and/or other such system that is in communication with the fulfillment management circuit. The OHMD systems are configured to be in wireless communication with the fulfillment management circuit.

Accordingly, the fulfillment management circuit 102 wirelessly communicates route information corresponding to each respective one of the product collection routes and product identifier information of at least one of the requested products to be retrieved that is stored in the retail store along the product collection routes to each of the OHMD systems 104 associated with each of the identified one or more workers who are to collect products. The fulfillment management circuit causes at least a portion of the route information, and when relevant product identifier information of one or more products, to be visually displayed and/or audibly reproduced through the respective one of the plurality of OHMD systems worn by each of the one or more workers. This allows the worker to perform the product picking and collection without having to pick up a printed list or look at a separate display (e.g., the display of a handheld user interface unit 122). Accordingly, the time to collect products can be reduced, while improving the accuracy of the collection.

Typically, the OHMD systems include a location detection system that identifies a current location of the OHMD system and/or communicates information to the fulfillment management circuit, the mapping system, and/or an OHMD system location tracking system that can identify current locations of the OHMD systems and/or track movements of the OHMD systems. In some applications, the fulfillment management circuit receives location information of the corresponding OHMD systems and communicates portions of the collection route that is within a route threshold distance of the current location of the OHMD system, and product information for one or more products that are within a product threshold distance, which may be the same distance or a different distance than the route threshold distance, and/or for a threshold number of products. The fulfillment management circuit may further consider other factors in determining an amount of the collection route and/or product information that is communicated, such as but not limited to a total number of products to be collected, a total distance to be traveled, size of a zone the worker is assigned to collect from, a worker's experience in collecting products, a worker's historic efficiency in collecting products, a worker's familiarity with a zone and/or products assigned to be retrieved, a worker's history of collecting products for one or more of the customers, other such factors, or combination of two or more of such factors.

Additionally or alternatively, the OHMD systems 104 may limit the amount of the collection route and/or product information that is displayed based on the one or more factors (e.g., display real estate, size and/or complexity of the route, number of products to collect, worker's experience, worker's history, etc.). Still further, in some implementations the worker, through interfacing with the OHMD system 104, may be able to control an amount of the collection route and/or product information that is provided to the OHMD system and/or displayed through the OHMD system. For example, the worker may be able to zoom out to view more of the collection route and/or zoom in to view more details about the collection route. Similarly, the worker may be able to effectively zoom out on product information (e.g., seeing less information for each product and/or seeing information for more different products) and zoom in on product information (e.g., seeing information for fewer products and/or seeing more details about one or more products to be collected). As such, in some embodiments, the fulfillment management circuit may communicate some or the entire collection route information and/or product information allowing the worker and/or the OHMD system to control the amount of the collection route and/or product information that is displayed and/or audible reproduced for the worker through the OHMD system.

In some embodiments, the fulfillment management circuit may further provide the assigned workers with information regarding a number of product containers and/or types of product containers the worker is to use and/or transport along the collection route in collecting the assigned products. For example, some product containers may be insulated and intended to receive products that are to be maintained within a range of one or more threshold temperatures. Similarly, a product container may include a cooling system and/or heating system, and products that are to be collected that are to be maintained at or within a threshold range of a specified temperature may be inserted into one of these product containers once collected by the worker. Further, in some instances and/or for one or more products, the fulfillment management circuit further has access to information regarding dimensions, weight and other information about products to be collected. The fulfillment management circuit can determine a number, size and/or type of product container to be transported by the worker in collecting the one or more assigned products based on the dimensions, weight and other such factors. The number, size and/or type of one or more product containers that the worker is to use can similarly be communicated to and caused to be displayed and/or audibly reproduced to the worker prior to and/or as the worker is implementing the collection. In some applications, the fulfillment management circuit and/or the OHMD system may further verify the size, type and/or number of product containers a worker retrieves (e.g., based on video and/or image processing, detection of product container identifiers (e.g., bar code), and/or other such methods). A notification can be displayed and/or audibly generated through the OHMD system when an incorrect type, size and/or number of product containers are retrieved.

Further, in some embodiments, the fulfillment management circuit may provide additional assistance to the worker in identifying a route to travel, products to pick and/or product containers into which products are to be placed. For example, the control management system may distinguish one or more aisles to enter, product to retrieve, and/or product containers into which one or more products are to be placed. This distinguishing can be through displaying a highlighting and/or a displayed different color overlaid in the field of view of the worker. In some applications, the OHMD systems capture images and/or video. The images and/or video can be processed by the OHMD system and/or forwarded to the fulfillment management circuit (and/or a separate image processing and/or video processing system). For example, one or more products can be identified and their locations within the field of view of the worker can be determined. With this information, the OHMD system and/or the fulfillment management circuit can cause one or more distinctions to be displayed (e.g., change of coloring, a circle displayed around a pick container of interest, or the like) in the field of view of the worker that distinguishes one or more products on a shelf of multiple shelves, and/or one of multiple product containers.

In some implementations, the fulfillment management circuit 102 receives one or more images and/or video from an OHMD system 104 of a shelf system that contains multiple shelves each with different products. Based at least in part on the one or more images and/or video, a product can be detected and identified. The fulfillment management circuit can cause the OHMD system to display a highlighting in the field of view of the worker consistent with a location of the product that visually distinguishes one or more products of the multiple different products to be retrieved. Similarly, distinctions and/or displayed guidance can be displayed based on a current location and field of view visible to the worker.

In some instances, one or more of the assigned workers may be unavailable (e.g., helping a customer, in the middle of another task, etc.). Accordingly, the worker may be able to response through the OHMD system that she/he is unavailable. The fulfillment management circuit can then reevaluate the workers, customer orders, and the like in assigning a different worker and/or redefining collection routes and products to be collected by one or more workers. Additionally or alternatively, the fulfillment management circuit may modify a worker's collection list of products. This modification is typically based on areas of the retail store the worker has already traveled in collecting products and/or the product being collected.

Some embodiments continuously update the collection route information and product information based on one or more workers' movements through the retail store. The fulfillment management circuit 102 and/or the OHMD system 104 determine and/or receive location information associated with each of the OHMD systems associated with the one or more workers. This location information may be based on video and/or image processing of video and/or images captured by one or more cameras in the retail store, and/or video and/or image processing from video and/or images captured by one or more cameras of an OHMD system. Further, in some implementations the OHMD system may include a global positioning system (GPS) that can receive and track location information based on received GPS coordinates. In some embodiments, the OHMD system may include movement sensors (e.g., inertial sensors, motion sensors, distance measurement sensors, compass, and/or other such sensors) that can be used to determine location and/or track movements of the OHMD system. The OHMD system may further include one or more light detectors to detect the light from the lighting system that includes one or more light units that emit light with information encoded into the emitted light, which may include light source identifier information, area identifier or number, location information, and/or other such information or combination of such information. This information can be used by the OHMD system and/or communicated to the fulfillment management circuit to be used in determining and/or tracking a location of the OHMD system. In some applications, the OHMD system includes a machine readable code reader that can detect machine readable codes and/or can capture images of machine readable codes that are spaced at predefined locations in the retail store that can be used to determine a current location. Other methods of tracking movement can be used, including but not limited to triangulation based on wireless signals and sources of wireless signals, tracking rotations of wheels of an item container, and other such methods.

Based on the location information, the fulfillment management circuit and/or the OHMD system may identify one or more subsequent products to be retrieved along the corresponding product collection route or routes. When determined by the fulfillment management circuit, the fulfillment management circuit can cause updated route information and further product identifier information corresponding to the subsequent product based on the location information to be communicated to a corresponding OHMD system, and cause the updated route information and further product identifier information to be displayed on correspond ones of the OHMD systems associated with the one or more workers.

The workers that are tasked to collect products each collects products from at least one order and often from multiple different orders while implementing the collection route. As such, the workers are not restricted to collecting products for a single product order. In some instances, the fulfillment management circuit in determining the separate product collection routes determines the separate product collection routes such that each of the one or more workers, while retrieving products along a single product collection route, retrieves products from at least one of one or more product orders. Workers, in picking and/or collecting products, previously had to use handheld scanners to identify and retrieve products. This can slow down the process as pickers hands are occupied, and making their job less efficient. In some embodiments, however, the OHMD system and/or fulfillment management circuit can identify products collected (e.g., scan a bar code, image recognition, etc.) and confirm the accuracy of a product collected corresponds to an ordered product the worker is intended to collect. Workers receive the collection route, product information and/or collection instructions through their respective OHMD systems that helps the workers navigate to the aisles containing the products they are assigned to pick.

The use of the OHMD systems can further improve the retrieval of products by directing a worker to an alternative or secondary location when a first or primary location where a particular product is supposed to be located does not have any further requested product or does not have enough of the requested product. In some embodiments, the fulfillment management circuit 102 further identifies when there is an insufficient quantity of a first product of the requested product at a primary location from which the first worker is to retrieve the quantity of the first product, and/or receives, from an OHMD system associated with a worker of the one or more workers, a notification that there is an insufficient quantity of the first product at the primary location. In some implementations, the OHMD system may capture video and/or images of the location where the first product is supposed to be located. Through image processing and/or video processing the fulfillment management circuit and/or the OHMD system may determine a number of remaining first products if any are at the location. In some instances, the OHMD system and/or the fulfillment management circuit can count the number of the first product retrieved from a shelf or other support structure and identify that less than to a specified number of products were retrieved. Additionally or alternatively, the worker may input the notification that there is an insufficient quantity of the first product and/or response to a request confirming there is insufficient quantities. The fulfillment management circuit, in some implementations, can further identify one or more additional locations within the retail store where the first product is expected to be available. It is very common in retail stores to have some products at more than one location (e.g., on one or more shelves in a predefined area of similar products, as well as at one or more endcaps of an aisle). The fulfillment management circuit may access the inventory system and/or store product mapping to identify whether there is one or more additional or secondary locations where the first product is further displayed on a sales floor of the retail store and/or other secondary location that is accessible to the worker (e.g., back storage area, overflow bins, etc.). The fulfillment management circuit can further update the route information for one or more of the workers, such as to direct the first worker (or a different worker) to the secondary location to retrieve the first product, and can cause the updated route information to be wirelessly communicated to the OHMD system associated with the first worker.

Similarly, in some embodiments, the fulfillment management circuit can further receive information from an OHMD system that can be used to initiate restocking and/or detect when a product needs to be restocked and/or is out of stock on the shelf or other product support structure at the primary location. For example, the fulfillment management circuit may perform image processing and/or video processing of images and/or video captures by the OHMD system at the primary location and identify that the product needs restocking. The fulfillment management circuit may identify from the image data that a quantity, on a sales floor of the retail store, of a first product of the requested products is less than a quantity threshold. Further, the fulfillment management circuit may generate a restocking task to cause an additional worker to restock an additional quantity of the first product on the sales floor, and/or communicate with the inventory system 112 and/or a worker task system that can generate the task and/or identify a worker that can perform the task. Some embodiments additionally or alternatively enable a worker to adjust inventory to a remaining count and/or zero based on remaining products prior to and/or after the worker picks the ordered product. The fulfillment management circuit may further identify when a product is out of stock, and may further select a substation product that is added to or replaces the out of stock product in the collection list and/or product information.

In some embodiments, the product order fulfillment system 100 further enables cross-product selling and/or identifying additional products in cross-selling. The fulfillment management circuit, in some applications, can identify a first customer associated with a first product order of the multiple different product orders. Customer information can be accessed (e.g., through the database, the inventory system, a customer profile system, or the like, and based on a purchase history associated with the first customer, one or more additional products that is not included in a current product order can be identified and that correspond to one or more of the product requested by the first customer in the current product order. In some instances, the worker may further be familiar with the customer and other products that the customer often purchases. As such, the worker may submit one or more additional products to be considered for cross-selling (e.g., through voice input, through a separate user interface unit (e.g., smart phone. tablet, product scanning system, etc.)). The fulfillment management circuit and/or the order receiving system may add the additional one or more products to the first product order. The addition, in some instances, may be a conditional addition and the customer is contacted to confirm that the customer wants the additional one or more products prior to the one or more additional products being actually delivered to the customer. In other instances, the customer profile associated with the first customer may designate a preauthorization for one or more designated products. The fulfillment management circuit in determining the separate product collection routes can further determine a portion of a route to cause a worker of the one or more workers to retrieve the additional one or more product even though the first customer did not request the first product.

Some embodiments further track products as they are retrieved by workers and may further track into which product container of one or more product containers the worker places the product after retrieving the product. Again, the workers often retrieve ordered products from the sales floor. As such, the workers often carry and/or push one or more product containers along the collection routes and place products into one of the product containers or carriers as the worker continues to collect one or more additional products and/or in taking the collected products to a sorting and/or consolidation area. Because workers are often collecting products for more than one product order for more than one customer, the fulfillment management circuit can track the placement of the products into different product containers, which can simplify the later order consolidation of products. In some applications, the fulfillment management circuit receive images and/or video data captured by each of the OHMD systems associated with each of the one or more workers while the one or more workers are retrieving the requested products of the multiple different product orders. From the image data, the fulfillment management circuit can identify into which of a plurality of product containers a first worker places each product retrieved by the first worker while the first worker is retrieving the requested products. A listing of the retrieved products in each of the plurality of product containers can be maintained at the fulfillment management circuit, a database, order receiving system and/or other such system. The consolidation and loading of products and delivery bins according to product orders into one or more delivery vehicles in accordance with some embodiments is described in U.S. Provisional Application No. 62/275,886, for Donald R. High et al., entitled SYSTEMS AND METHODS OF CONSOLIDATING PRODUCT ORDERS, which is concurrently filed herewith and is incorporated herein by reference. Further, the delivery of products according to product orders by delivery vehicles in accordance with some implementations is described in U.S. Provisional Application No. 62/275,891, for Donald R. High et al., entitled SYSTEMS AND METHODS OF ASSISTING IN THE DELIVERY OF PRODUCTS, which is concurrently filed herewith and is incorporated herein by reference.

Additionally, in some instances, the OHMD system can display to a worker the list of products in a particular product containers. The fulfillment management circuit and/or the OHMD system may identify a product containers (e.g., based on image processing, detecting a container identifier from an RFID signal and/or an optically readable code, based on a placement of the product container, and/or other such information). The fulfillment management circuit can cause one or more listings, of the maintained listings of the retrieved products, that each identifies the retrieved products that are in the respective product containers to be displayed on and/or audibly reproduced by an OHMD system associated with the worker.

Some embodiments may further identify products being placed into the one or more product containers and can verify that the products are those that are in the customer order and/or added based on cross-selling. In some instances, the product may be identified through RFID detected by the OHMD system or other RFID detector, optical scan of a bar code or other such identifier code, image processing of an image of the product, and/or other such methods or combination of two or more of such methods. The identification can further include obtaining additional information from the inventory system, or other system. Once identified, the product can be cross referenced with the product order and confirmed that the product is the ordered product and/or added product. As such, the system can validate each item picked as corresponding to the product instructed to be picked. For example, the picked products can be scanned through one or more cameras of the OHMD system as they are picked and placed in product container, and processed to identify the product. This is compared to the ordered products to confirm the accuracy of the picked product.

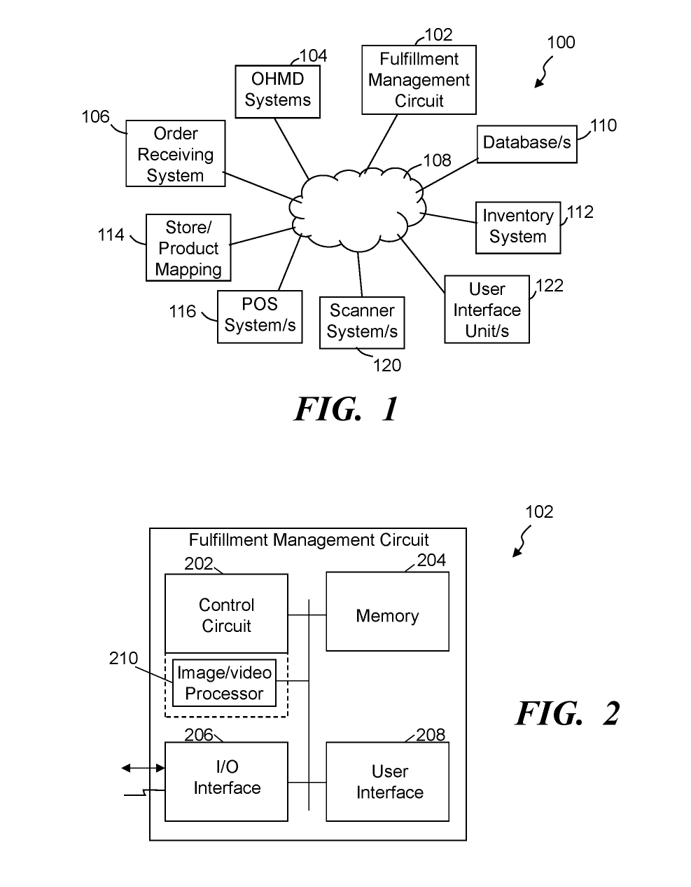

FIG. 2 illustrates a simplified block diagram of an exemplary fulfillment management circuit 102, in accordance with some embodiments. The fulfillment management circuit 102 includes one or more fulfillment control circuits 202, memory 204, and one or more input/output (I/O) interfaces 206. In some implementations, the fulfillment management circuit includes one or more user interfaces 208 configured to allow workers to interact with the fulfillment management circuit to provide relevant information to the fulfillment management circuit, and/or provide information to the workers. Additionally, in some applications the fulfillment management circuit includes and/or couples with one or more image and/or video processors 210 that provide image processing of at least images, which may include video processing, captured by one or more cameras 212 of the OHMD systems 104. While FIG. 2 illustrates the various components being coupled together via a bus, it is understood that the various components may actually be coupled to the control circuit 202 and/or one or more other components directly.

In some embodiments, the control circuit 202 comprises one or more processors and/or microprocessors. The control circuit couples with and/or includes the memory 204. Generally, the memory 204 stores the operational code or one or more sets of computer instructions that are executed by the control circuit 202 and/or processor to implement the functionality of the fulfillment management circuit. In some implementations, the memory may further stores collection route information, product information, product placement, mapping information, customer information, product orders, and other such data. Such data may be pre-stored in the memory or be received.

It is understood that the control circuit may be implemented as one or more processor devices as are well known in the art. Further, the control circuit may utilize remote processors dispersed over a distributed communication network (e.g., LAN, WAN, Internet, etc.). Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the fulfillment management circuit; however, the memory 204 can be internal, external or a combination of internal and external memory. Similarly, the memory may be dispersed over a distributed communication network.

In some instances, the control circuit 202 and the memory 204 may be integrated together, such as in a microcontroller, application specification integrated circuit, field programmable gate array or other such device, or may be separate devices coupled together. In some applications, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 206 allow wired and/or wireless communication coupling of the fulfillment management circuit 102 to external components, the OHMD systems 104, the order receiving system 106, the databases 110, the inventory system 112, store mapping 114, scanner systems 120, user interface units 122, and other such components. Accordingly, the I/O interface 206 may include any known wired and/or wireless interfacing device, circuit and/or connecting device, such as but not limited to transceivers, receivers, transmitters, and the like. For example, in some implementations, the I/O interface 206 provides wireless communication in accordance with one or more wireless protocols (e.g., cellular, Wi-Fi, Bluetooth, radio frequency (RF), other such wireless communication, or combinations of such communications).

In some embodiments the fulfillment management circuit may include and/or couple with one or more user interfaces 208. The user interface can include substantially any known input device, such one or more buttons, knobs, selectors, switches, keys, touch input surfaces, scanners, displays, etc. Additionally, the user interface may include one or more output display devices, such as lights, visual indicators, display screens, etc. to convey information to a user, such as product priority, threshold information, inventory information, product information, product identifiers, notifications, errors, conditions and/or other such information.

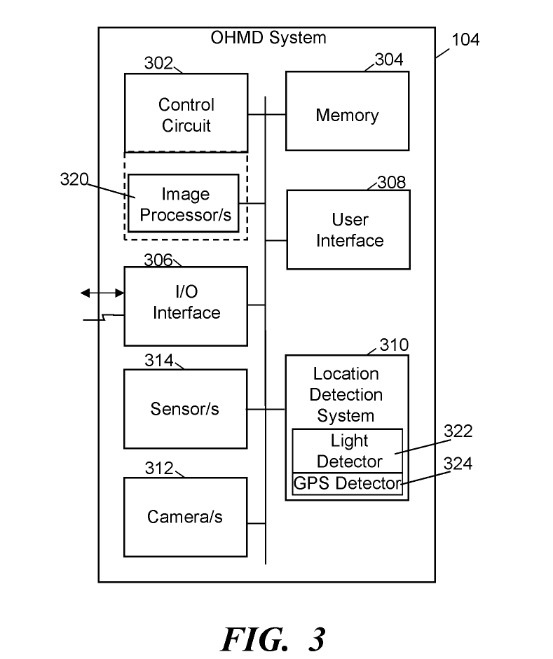

FIG. 3 illustrates a simplified block diagram of an exemplary OHMD system 104, in accordance with some embodiments. The OHMD system includes one or more OHMD control circuits 302, one or more memory 304, one or more input/output (I/O) interfaces and/or devices 306, and one or more user interfaces 308. Some embodiments further include one or more location detection systems 310, one or more cameras 312, one or more sensors 314, and/or other such systems and/or circuitry. Additionally, the OHMD system typically includes one or more power supplies (not shown), where one or more of such power supplies may be rechargeable, and/or the OHMD system may at least temporarily receive power from an external source. While FIG. 3 illustrates the various components being coupled together via a bus, it is understood that the various components may actually be coupled to the OHMD control circuit 302 and/or one or more other components directly.

The OHMD control circuit 302 typically comprises one or more processors and/or microprocessors and couples with the memory 304 that stores operational codes or sets of computer instructions that are executed by the OHMD control circuit 302 and/or processor to implement the functionality of the OHMD system 104. For example, in some applications, the OHMD control circuit may include and/or couple with one or more image processors 320 that provide image processing of at least images, which may include video processing, captured by one or more cameras 312 of the OHMD system 104. In some embodiments, the memory 304 may also store some or all of particular data that may be needed to at least provide the worker with the collection route information and product information.

It is understood that the OHMD control circuit 302 may be implemented as one or more processor devices as are well known in the art. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the OHMD system 104; however, the memory 304 can be internal, external and wirelessly accessible, or a combination of internal and external memory.

Generally, the OHMD control circuit 302 and/or electronic components of the OHMD system 104 can comprise fixed-purpose hard-wired platforms or can comprise a partially or wholly programmable platform. These architectural options are well known and understood in the art and require no further description here. The OHMD system and/or OHMD control circuit 302 can be configured (for example, by using corresponding programming as will be well understood by those skilled in the art) to carry out one or more of the steps, actions, and/or functions described herein. In some implementations, the OHMD control circuit 302 and the memory 304 may be integrated together, such as in a microcontroller, application specification integrated circuit, field programmable gate array or other such device, or may be separate devices coupled together.

The I/O interface 306 allows wired and/or wireless communication coupling of the OHMD system 104 to external components, such as fulfillment management circuit 102, store and/or product mapping system 114, inventory system 112, user interface units 122 (e.g., smart phone, tablet, other OHMD system, smart watch systems, and other such consumer electronic user devices), databases 110, scanner systems 120, and other such devices or systems. Typically, the I/O interface 306 provides at least wireless communication (e.g., cellular, Wi-Fi, Bluetooth, RF, and/or other such wireless communication), and in some instances may include any known wired and/or wireless interfacing device, circuit and/or connecting device, such as but not limited to one or more transmitter, receiver, transceiver, etc.

The OHMD system further includes one or more user interfaces 308 that can be used for user output and/or input. For example, the user interface 308 may include any known input devices, such one or more buttons, knobs, selectors, switches, keys, touch input surfaces, audio input, and/or displays, audio detector to receive spoken commands, etc. Additionally, the user interface 308 includes one or more display projection systems and corresponding display surfaces (e.g., lens(es) of glasses), lights, visual indicators, etc. to convey information to a worker. Similarly, the user interface 308 in some embodiments may include audio systems that can receive audio commands or requests verbally issued by a worker, and/or output audio content, instructions, alerts and the like.

The OHMD systems 104 typically further include one or more cameras 312 that capture images and/or video that can be evaluated by the OHMD control circuit 302 and/or communicated to the fulfillment management circuit 102 for processing, and/or other systems. In operation, the OHMD control circuit 302 can activate one or more of the cameras 312. In some embodiments, one or more pictures and/or video captured by the camera/s 312 of the OHMD system can be evaluated for one or more parameters, rules and/or conditions as described above.

The location detection system 310 determines and/or obtains location information to determine a current location of and/or track the location and movements of the OHMD system. In some embodiments, the OHMD control circuit 302 and/or the fulfillment management circuit 102 can utilize the location information, for example, in determining which portions of the collection route and/or product information to display and/or audibly reproduce, when to display and/or highlight portions of the collection route and/or product information, providing directional information to the worker, and the like. Similarly, as described above the fulfillment management circuit additionally can use the location information communicated from the OHMD system (e.g., determine portions of the collection route and/or product information to provide to the OHMD system, updating collection routes and/or product information, tracking collection progress, confirming accuracy of products, etc.).

In some instances, the location detection system 310 may include a global positioning detection system or circuit 324 that received global positioning coordinate information, Wi-Fi signal triangulation and/or evaluation system, cellular tower triangulation system, and/or other such location detection system. In some embodiments, the location detection system 310 includes and/or couples with one or more light detectors 322 that detect and/or decode encoded information from lights in the retail store, where the lights are at known locations, and/or other such location information acquisition systems. Further, the location detection system may use information provided by one or more sensors 314 in determining and/or tracking location information. The sensors can include substantially any relevant sensor such as, but not limited to, one or more inertial sensors, accelerometers, gyroscopes, compass, distance measurement systems (e.g., ultrasound, laser, etc.), and/or other such sensor information. The OHMD system 104 may include one or more additional or alternative sensors 314 that provide information that may be used for location detection, such as but not limited to wireless signal strength sensor, and the like.

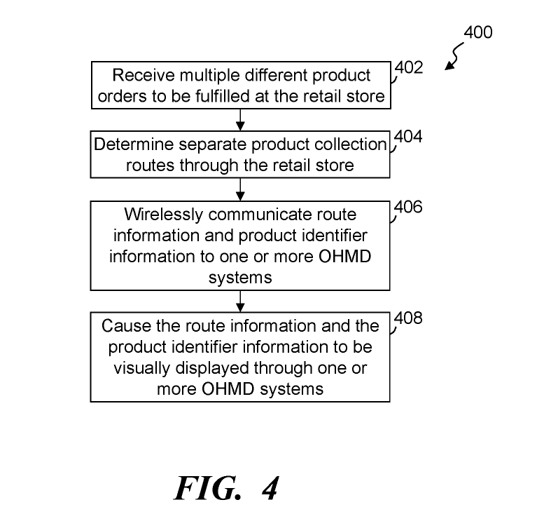

FIG. 4 illustrates a simplified flow diagram of an exemplary process 400 of fulfilling product orders through one or more retail stores, in accordance with some embodiments. In step 402, multiple different product orders to be fulfilled at the retail store are received at a fulfillment management circuit 102 of a customer order fulfillment system 100 associated with a retail store. Again, in some applications, the customer orders are initially compiled and/or received through an order receiving system 106 that forwards the customer orders to be fulfilled to the fulfillment management circuit 102.

In step 404, separate product collection routes through the retail store are determined that are each to be respectively followed by one of one or more workers in collecting the requested products for the multiple different product orders. Further, the collection routes are typically determined such that any aisle from which one of the requested products is to be retrieved is only traveled along once by a single one of the one or more workers in retrieving the requested products stored along the respective aisle for the multiple product orders. In step 406, route information and product identifier information is wirelessly communicated to each of a plurality of OHMD systems that are each associated with one of the one or more workers. The route information corresponds to a respective one of the product collection routes and the product identifier information identifies at least one of the requested products to be retrieved that is stored along the product collection routes.

In step 408, the route information and the product identifier information are caused to be visually displayed and/or audibly reproduced through the respective one of the plurality of OHMD systems worn by each of the one or more workers. Accordingly, each worker that is tasked to collect one or more products for the multiple customer orders is associated with an OHMD system. The fulfillment management circuit causes the collection route information and product information (e.g., product identifier information, size information, bar code information, quantity information, and/or other such product information) determined for each of the plurality of workers associated one of the plurality of OHMD systems to be communicated to and displayed by the respective OHMD systems. The workers can follow the collection route information and collect the products assigned to be retrieved by the worker.

Typically, in assigning collection routes and the products workers are to collect, each worker collects products from multiple different orders. Accordingly, the separate product collection routes are determined, in some applications, such that each of the one or more workers, while retrieving one or more products along a single product collection route, retrieves products from one or more and often at least two of the multiple different product orders. Some embodiments periodically and/or continuously update route information and product information based on one or more workers' movements. Location information is received that is associated with each of the OHMD systems associated with the one or more workers. A subsequent product to be retrieved along the corresponding product collection routes can be identified based on the location information. Updated route information and further product identifier information corresponding to the subsequent product based on the location information can be communicated and caused to be displayed on correspond ones of the OHMD systems associated with the one or more workers.

Some embodiments may further detect when one or more products are out of stock on the shelf and cause a pick task to be generated. The fulfillment management circuit can receive image data captured by an OHMD system and identify from the image data that a quantity, on a sales floor of the retail store, of a product of the requested products is less than a quantity threshold. A restocking task can be generated to cause an additional worker to restock an additional quantity of the first product on the sales floor.

Further, some embodiments may direct workers to secondary locations when primary locations do not have a sufficient quantity of an ordered product. A notification may be received from an OHMD system associated with a worker that there is an insufficient quantity of a product of the requested product at a primary location from which the worker is to retrieve the quantity of the product. It can be identified that the product is further displayed on the sales floor of the retail store at a secondary location. The route information can be updated to direct the worker to the secondary location to retrieve the product, and the updated route information is wirelessly communicated to the OHMD system.

Some embodiments identify a customer associated with a product order of the multiple different product orders, and identify, based on a purchase history associated with that customer, one or more additional products that are not included in the product order. In some instances, one or more additional products may correspond to a product requested by the customer in the product order. One or more of the additional product can be added to the product order. A portion of a collection route is determined to cause a worker to retrieve the additional product even though the customer did not request the one or more additional products.

In some embodiments, image data is received that is captured by each of the OHMD systems associated with each of the one or more workers while the one or more workers are retrieving the requested products of the multiple different product orders. The system can identify, from the image data, into which of a plurality of product containers a worker places each product retrieved by the worker while the worker is retrieving the requested products. One or more listings can be maintained of the retrieved products in each of the plurality of product containers. Further, one or more of the listings, of the maintained listings of the retrieved products, that identifies the retrieved products that are in one or more product containers of the plurality of product containers can be displayed on an OHMD system of with a worker.

Further, the customer order fulfillment system 100 applies sets of rules from one or more rules databases 110, network accessible memory, local memory, rules engines and/or other such sources. The rules can comprise or be organized according to one or more sets of rules such as, but not limited to, one or more sets of rules for product collection, one or more sets of product substitution rules, one or more sets of damaged product rules, one or more sets of retail facility tracking rules, one or more sets of crowd souring rules, one or more sets of consolidation and distribution rules, other such sets of rules, and typically a combination of multiple of such sets of rules. These sets of rules can be applied, in part, to determine whether to combine multiple orders, how to combine orders, how to allocate products for different numbers of workers, how to define the collection routes for one or more workers, whether and/or how to address a detected damaged product, whether and/or how to address a detection that another product not being collected is empty or below a threshold, how to address a detection that an ordered product is not present on the shelf on the sales floor, how to address a detection that an ordered product is not available, and other such rules, or combinations of two or more of such rules.

Some embodiments in defining collection routes apply product crush rules that considers products crush factors corresponding to weights that products can withstand being stacked on top of the product. Other crush factors may correspond to impacts that can be withstood by product packaging, in cooperation with weights of other products, likelihood of shifting position of other products (e.g., eggs being placed within a bin or container with one or more cans of vegetables), other such factors, or combination of two or more of such factors. These rules can limit what types of products a worker may collect along a collection route, and as such, the collection route and corresponding products to be picked up during a collection route may be limited because of potential damage to a product from one or more other products.

Further, some embodiments utilize prohibition rules that limit the types of products that can be placed into the same bag, bin, basket or the like with other types of products. For example, many products include chemicals that should not be eaten by customers. Accordingly, some prohibition rules limit some foods from being collected with other types of products that have chemicals that should not be ingested by customers. Similarly, some collection routes may restrict what products can be placed in the same bag, bin, basket or the like with other products. As such, a collection route may include the collection of products that should not be put together, while the collection route additionally directs the worker to place those products into different bags, bins, etc. Again, the OHMD system can direct the picker in the selection of products as well as the placement upon collection (e.g., by highlighting different bins, bags, or the like into which different products are to be placed). The OHMD system may further confirm that products are not placed into the same bag, bin, etc. with other non-compatible products, such as through image processing, ID scanning (e.g., product bar codes, bin bar codes, etc.), and/or other such evaluations.

Some embodiments further apply grouping rules in evaluating multiple product orders in determining when and how to group orders or portions of orders in defining collection routes. In some implementations, the grouping rules may define groupings based on areas or grids of the retail facility and the products within those areas (e.g., meat department, frozen food department, etc.). Some embodiments apply grouping rules that group products along one or more predefined routes or portions of routes. Similarly, some groupings rules define groupings of products based on types of products, based on contents within the products (e.g., types of chemicals, ingestible, etc.), types of packaging, levels of fragility, and the like.

Further, some embodiments apply one or more sets of picking rules that can help the pickers in picking products and addressing issues related to picking. For example, the picking rules may include one or more substitution rules that define when and how products should be substituted when a product to be picked is not available. Further, the substitution rules may include customer defined picking rules that are applied in determining whether and when to substitute product and/or w what products to substitute. For example, a customer may define that when a generic brand of laundry detergent being requested is not available, then pick a specific type of Tide laundry detergent. As another example, a customer defined rule may request that the customer be notified and authorize a substitution before the substitution is implemented. Some embodiments include picking rules that address a situation where a product is not available at a specified location (based on the route) on the sales floor but is available at another location on the sales floor and/or in a back storage area. For example, one or more picking rules may direct the evaluation of inventory data to determine whether it is available in another area, whether to direct the picker to another location within the shopping facility, whether to remove the product from the pick list for that picker and add the product to another pickers pick list (e.g., based on that picker's location, route, etc.), and/or other such rules.

Further rules may apply when the system identifies that one or more product areas (e.g., area on a shelf) near a product being picked and/or along a pick route are empty or below a threshold level, and what actions are to be initiated in response to that situation. Some embodiments further utilize the one or more cameras on the OHMD in cooperation with captured image and/or video analytics to detect vacant areas on a shelf, rack, module, etc. Further, the OHMD may include one or more gyroscopes, compass, accelerometers, and the like to aid in tracking the location and orientation of the OHMD to identify the vacant area. The rules may further dictate when and how to notify the inventory system, whether to initiate a restocking, and other such actions. The system can further evaluate image and/or video data to detect location identifying information (e.g., shelf bar code, code on the floor, isle identifiers, neighboring products, etc.).

In some embodiments, one or more damaged product rules are applied that are used to identify when a product is damaged (e.g., shape is inconsistent with expected shape, labeling is partially or fully non-detectable, detected date is inconsistent with date threshold, and/or other such damage). Further, the damaged product rules may define an action to take regarding the damages product (e.g., whether to leave the product, whether to direct another picker to pick up the damaged product, whether to direct the picker to retrieve the damaged product but not place it into a bin, bag, etc. that is being used to collect ordered products, where the damaged product should be taken, whether to direct the picker to pick a different item of the same product, and/or other such rules, whether to update inventory information (e.g., notifying that two of the products are removed from the shelf when another item of the product is picked for the customer as well as the damaged product).

Some embodiments include a set of crowd sourcing rules that can be applied when customers within the store are acting as pickers to fulfill the received orders from other customers. Such rules may override some of the routing, for example, a single order may be directed to a crowd source picker to simplify the picking, one or more rules may result in different routes based on the products that the customer crowd source picker intends to purchase while at the shopping facility, and the like.

In some embodiments, systems, apparatuses and methods are provided to fulfill product orders. Some embodiments comprise product order fulfillment systems, comprising: a plurality of optical head-mounted display (OHMD) systems; and a customer order fulfillment system associated with a retail store and configured to wireless communicate with each of the plurality of OHMD systems, and comprising a fulfillment management circuit and memory storing computer instructions that when executed by the fulfillment management circuit cause the fulfillment management circuit to: receive multiple different product orders to be fulfilled at the retail store determine separate product collection routes through the retail store that are each to be respectively followed by one of one or more workers to collect the requested products for the multiple different product orders such that any aisle from which one of the requested products is to be retrieved is only traveled along once by a single one of the one or more workers in retrieving the requested products stored along the respective aisle for the multiple product orders; and wirelessly communicate route information corresponding to a respective one of the product collection routes and product identifier information of at least one of the requested products to be retrieved that is stored along the product collection routes to each of the OHMD systems associated with each of the one or more workers and cause the route information and the product identifier information to be visually displayed through the respective one of the plurality of OHMD systems worn by each of the one or more workers.

Some embodiments include methods of fulfilling product orders through a retail store, comprising: receiving, at a fulfillment management circuit of a customer order fulfillment system associated with a retail store, multiple different product orders to be fulfilled at the retail store; determining separate product collection routes through the retail store that are each to be respectively followed by one of one or more workers in collecting the requested products for the multiple different product orders such that any aisle from which one of the requested products is to be retrieved is only traveled along once by a single one of the one or more workers in retrieving the requested products stored along the respective aisle for the multiple product orders; and wirelessly communicating route information corresponding to a respective one of the product collection routes and product identifier information of at least one of the requested products to be retrieved that is stored along the product collection routes to each of a plurality of OHMD systems associated that are each associated with one of the one or more workers; and causing the route information and the product identifier information to be visually displayed through the respective one of the plurality of OHMD systems worn by each of the one or more workers.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A product order fulfillment system, comprising:
a plurality of optical head-mounted display (OHMD) systems; and
a customer order fulfillment system associated with a retail store and configured to wireless communicate with each of the plurality of OHMD systems, and comprising a fulfillment management circuit and memory storing computer instructions that when executed by the fulfillment management circuit cause the fulfillment management circuit to:
receive multiple different product orders to be fulfilled at the retail store;
determine separate product collection routes through the retail store that are each to be respectively followed by one of one or more workers to collect the requested products for the multiple different product orders such that any aisle from which one of the requested products is to be retrieved is only traveled along once by a single one of the one or more workers in retrieving the requested products stored along the respective aisle for the multiple product orders; and
wirelessly communicate route information corresponding to a respective one of the product collection routes and product identifier information of at least one of the requested products to be retrieved that is stored along the product collection routes to each of the OHMD systems associated with each of the one or more workers and cause the route information and the product identifier information to be visually displayed through the respective one of the plurality of OHMD systems worn by each of the one or more workers.

2. The system of claim 1, wherein the fulfillment management circuit is further configured to:
receive location information associated with each of the OHMD systems associated with the one or more workers;
identify, based on the location information, a subsequent product to be retrieved along the corresponding product collection routes; and
communicate updated route information and further product identifier information corresponding to the subsequent product based on the location information and cause the updated route information and further product identifier information to be displayed on correspond ones of the OHMD systems associated with the one or more workers.

3. The system of claim 1, wherein the fulfillment management circuit in determining the separate product collection routes determines the separate product collection routes such that each of the one or more workers, while retrieving products along a single product collection route, retrieves products from at least two of the multiple different product orders.

4. The system of claim 1, wherein the fulfillment management circuit is further configured to:
receive image data captured by a first OHMD system of the plurality of OHMD systems;
identify from the image data that a quantity, on a sales floor of the retail store, of a first product of the requested products is less than a quantity threshold; and
generate a restocking task to cause an additional worker to restock an additional quantity of the first product on the sales floor.

5. The system of claim 1, wherein the fulfillment management circuit is further configured to:
receive, from a first OHMD system associated with a first worker of the one or more workers, a notification that there is an insufficient quantity of a first product of the requested product at a primary location from which the first worker is to retrieve the quantity of the first product;
identify the first product is further displayed on a sales floor of the retail store at a secondary location;
update the route information to direct the first worker to the secondary location to retrieve the first product; and
cause the updated route information to be wirelessly communicated to the first OHMD system.

6. The system of claim 1, wherein the fulfillment management circuit is further configured to:
identify a first customer associated with a first product order of the multiple different product orders;
identify, based on a purchase history associated with the first customer, an additional product that is not included in the first product order and that corresponds to a first product requested by the first customer in the first product order; and
add the additional product to the first product order, wherein the fulfillment management circuit in determining the separate product collection routes further determines a portion of a route to cause a first worker of the one or more workers to retrieve the additional product even though the first customer did not request the first product.

7. The system of claim 1, wherein the fulfillment management circuit is further configured to:
receive image data captured by each of the OHMD systems associated with each of the one or more workers while the one or more workers are retrieving the requested products of the multiple different product orders;
identify, from the image data, into which of a plurality of product containers a first worker of the one or more workers places each product retrieved by the first worker while the first worker is retrieving the requested products; and
maintain a listing of the retrieved products in each of the plurality of product containers.

8. The system of claim 7, wherein the fulfillment management circuit is further configured to:
cause a first listing, of the maintained listings of the retrieved products, that identifies the retrieved products that are in a first product container of the plurality of product containers to be displayed on a first OHMD system of the plurality of OHMD systems associated with the first worker.

9. A method of fulfilling product orders through a retail store, comprising:
receiving, at a fulfillment management circuit of a customer order fulfillment system associated with a retail store, multiple different product orders to be fulfilled at the retail store;
determining separate product collection routes through the retail store that are each to be respectively followed by one of one or more workers in collecting the requested products for the multiple different product orders such that any aisle from which one of the requested products is to be retrieved is only traveled along once by a single one of the one or more workers in retrieving the requested products stored along the respective aisle for the multiple product orders; and
wirelessly communicating route information corresponding to a respective one of the product collection routes and product identifier information of at least one of the requested products to be retrieved that is stored along the product collection routes to each of a plurality of OHMD systems associated that are each associated with one of the one or more workers; and
causing the route information and the product identifier information to be visually displayed through the respective one of the plurality of OHMD systems worn by each of the one or more workers.

10. The method of claim 9, further comprising:
receiving location information associated with each of the OHMD systems associated with the one or more workers;
identifying, based on the location information, a subsequent product to be retrieved along the corresponding product collection routes; and
communicating updated route information and further product identifier information corresponding to the subsequent product based on the location information and causing the updated route information and further product identifier information to be displayed on correspond ones of the OHMD systems associated with the one or more workers.

11. The method of claim 9, wherein the determining the separate product collection routes comprises determining the separate product collection routes such that each of the one or more workers, while retrieving products along a single product collection route, retrieves products from at least two of the multiple different product orders.

12. The method of claim 9, further comprising:
receiving, at the fulfillment management circuit, image data captured by a first OHMD system of the plurality of OHMD systems;
identifying from the image data that a quantity, on a sales floor of the retail store, of a first product of the requested products is less than a quantity threshold; and
generating a restocking task to cause an additional worker to restock an additional quantity of the first product on the sales floor.

13. The method of claim 9, further comprising:
receiving, from a first OHMD system associated with a first worker of the one or more workers, a notification that there is an insufficient quantity of a first product of the requested product at a primary location from which the first worker is to retrieve the quantity of the first product;
identifying that the first product is further displayed on a sales floor of the retail store at a secondary location; and
updating the route information to direct the first worker to the secondary location to retrieve the first product; and
causing the updated route information to be wirelessly communicated to the first OHMD system.

14. The method of claim 9, further comprising:
identifying a first customer associated with a first product order of the multiple different product orders;
identifying, based on a purchase history associated with the first customer, an additional product that is not included in the first product order and that corresponds to a first product requested by the first customer in the first product order; and
adding the additional product to the first product order, wherein the fulfillment management circuit in determining the separate product collection routes further determines a portion of a route to cause a first worker of the one or more workers to retrieve the additional product even though the first customer did not request the first product.

15. The method of claim 9, further comprising:
receiving image data captured by each of the OHMD systems associated with each of the one or more workers while the one or more workers are retrieving the requested products of the multiple different product orders;
identifying, from the image data, into which of a plurality of product containers a first worker of the one or more workers places each product retrieved by the first worker while the first worker is retrieving the requested products; and
maintaining a listing of the retrieved products in each of the plurality of product containers.

16. The method of claim 15, further comprising:
causing a first listing, of the maintained listings of the retrieved products, that identifies the retrieved products that are in a first product container of the plurality of product containers to be displayed on a first OHMD system of the plurality of OHMD systems associated with the first worker.
